(19) United States
(12) Patent Application Publication
(10) Pub. No.: US 2005/0234615 A1
(43) Pub. Date: Oct. 20, 2005

(54) Display for vehicle diagnostic system

(75) Inventors: Stephen K. Rigsby, Conway, AR (US); George M. Gill, Vilonia, AR (US)

Correspondence Address: MCDERMOTT WILL & EMERY LLP, 600 13TH STREET, N.W., WASHINGTON, DC, 20005-3096, US

(73) Assignee: SNAP-ON INCORPORATED

(21) Appl. No.: 11/099,625

(22) Filed: Apr. 6, 2005

Related U.S. Application Data
(60) Provisional application No. 60/562,551, filed on Apr. 16, 2004.

(51) Int. Cl. G01M 17/00

(52) U.S. Cl. 701/29; 701/33

(57) ABSTRACT

A vehicle diagnostic system includes a computing device configured to perform a diagnostic function and to generate a result for the diagnostic function and a display coupled to the computing device configured to display the result is provided. The display uses a non-CRT-based display technology, such as a plasma display panel (PDP).

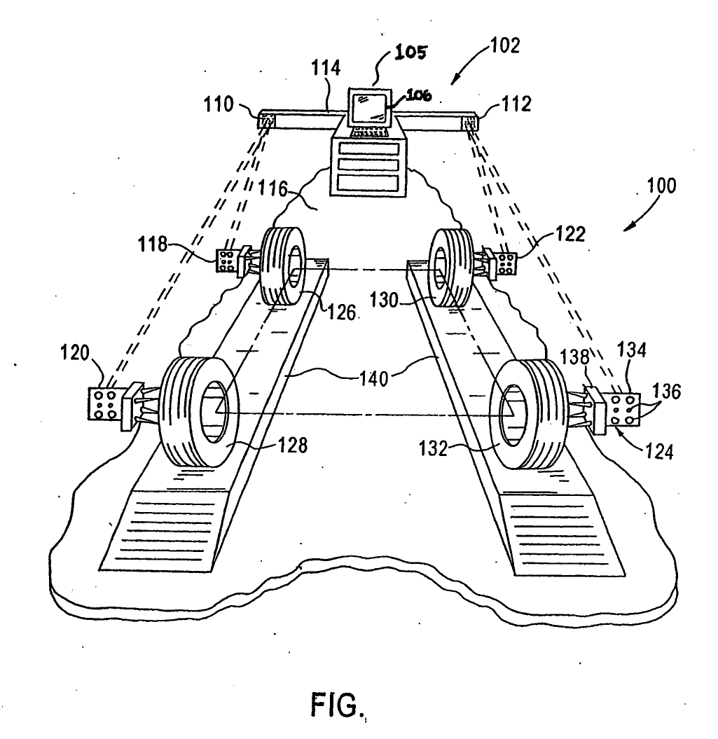

### RELATED APPLICATION

This application claims the benefit under 35 U.S.C. § 119(e) of U.S. Provisional Patent Application No. 60/562,551 filed on Apr. 16, 2004, entitled “Display For Vehicle Diagnostic System” which is incorporated by referenced herein its entirety.

### TECHNICAL FIELD

The present disclosure relates generally to diagnostic instruments, and more particularly, to a display system for use with a vehicle diagnostic system.

### BACKGROUND

Conventional vehicle service and diagnostic systems use cathode ray tube (CRT) based display technologies. Generally these displays have viewable areas measuring less than or equal to 19 inches. Although CRTs are well-suited to the demanding environment of an automotive service facility, CRTs also have several disadvantages. First, CRTs are heavy when compared with other, more recently developed display technologies (e.g., a liquid crystal display (LCD)). The weight of a CRT-based diagnostic instrument or system can limit the portability or mobility of the instrument.

Further, CRTs have considerably higher operational power consumption when compared with other display technologies. Again, the power consumption can make it difficult to operate a CRT-based diagnostic instrument in a portable manner.

Another drawback of using a CRT display with a diagnostic instrument is that the heavy display is typically located at the top of an enclosure or equipment cabinet for visibility purposes. This makes the cabinet top-heavy and difficult to maneuver around the service facility without tipping over.

What is needed is a display for use with a diagnostic system that does not use a heavy, high power consumption technology.

### SUMMARY

In one aspect, a vehicle diagnostic system includes a computing device configured to perform a diagnostic function and to generate a result for the diagnostic function and a display coupled to the computing device configured to display the result. The display uses a non-CRT-based display technology, such as a plasma display panel (PDP).

One advantage of the present disclosure is that the viewable area of the display can be increased while decreasing the weight of the diagnostic instrument or system. This allows for increased portability and safer maneuverability of the diagnostic instrument or system.

Additional aspects and advantages of the present disclosure will become readily apparent to those skilled in this art from the following concise and detailed descriptions, wherein only exemplary embodiments are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawing and description are to be regarded as illustrative in nature, and not as restrictive.

### BRIEF DESCRIPTION OF THE DRAWINGS

The accompanying drawings illustrate several embodiments and, together with the description, serve to explain the principles of the present disclosure.

FIGURE illustrates a position determination system including a computing device and a display screen.

### DETAILED DESCRIPTION OF THE EMBODIMENTS

The present disclosure is now described more fully with reference to the accompanying FIGURE, in which an embodiment is shown. One skilled in the art will recognize that methods, apparatus, systems, data structures, and computer readable media implement the features, functionalities, or modes of usage described herein. For instance, an apparatus embodiment can perform the corresponding steps or acts of a method embodiment.

Embodiments of the present disclosure are compatible with a variety of equipment present in vehicle service facilities, such as wheel alignment systems, frame straightening systems, engine diagnostic devices, and the like. Although the display system of the present disclosure is described below with reference to a position determination system, one skilled in the art will appreciate that the display system concepts apply to other types of equipment.

The FIGURE illustrates an optical position determination system (e.g., an automotive wheel alignment system) including a computing device 105. A display 106 is shown functionally coupled to the computing device 105 for displaying results, such as test information and the like. The position determination system is one example of a vehicle diagnostic system and is described briefly herein. The position determination system 100 includes a vision imaging system 102 (i.e., a data acquisition module) having a pair of fixed, spaced-apart cameras 110, 112 mounted on a beam 114. The beam 114 has a length sufficient to position the cameras 110, 112 respectively outboard of the sides of the vehicle to be imaged by the position determination system 100. Also, the beam 114 positions the cameras 110, 112 high enough above the shop floor 116 to ensure that the two targets 118, 120 on the left side of the vehicle are both within the field of view of the left side camera 110, and two targets 122, 124 on the right side of the vehicle are both within the field of view of the right side camera 112.

A vehicle under test is driven onto a lift 140. Targets 118, 120, 122, 124 are mounted on each of the wheels 126, 128, 130, 132 of the motor vehicle, with each target 118, 120, 120, 124 including a target body 134, target elements 136, and an attachment apparatus 138. The attachment apparatus 138 attaches the targets 118, 120, 120, 124 to the wheels 126, 128, 130, 132.

In operation, the targets 118, 120, 122, 124, are attached to the wheel rims and oriented such that the target elements 136 on the target body 134 face the respective camera 110, 112. Vehicle identifying information, such as the make and model year, and other customer-specific parameters can then be entered into the computing device 105 associated with the vision imaging system 102. The computing device 105 also includes a service database. The service database can include information about the work order associated with the vehicle under test.

The location of the targets 118, 120, 122, 124 relative to the rim of the wheels 126, 128, 130, 132 to which the targets are attached are typically known to an accuracy of about 0.01″ and about 0.01°. Once the targets 118, 120, 122, 124 have been imaged in one position, the wheels 126, 128, 130, 132 are rolled to another position and a new image can be taken. Using the imaged location of the targets 118, 120, 122, 124 in the two positions, the actual position and orientation of the wheels 126, 128, 130, 132 and wheel axis can be calculated by the computing device 105. Although the distance between the two positions varies, the distance is often approximately 8 inches.

The computing device 105 is coupled to cameras 110, 112 to receive the raw data (e.g., target positional signals). In practice, a mathematical representation, or data corresponding to a true image (i.e., an image taken by viewing the target device perpendicularly to its primary plane) and the dimensions of targets 118, 120, 122, 124 are preprogrammed into the memory of the computing device 105 so that, during the alignment process, the computing device 105 has a reference image to which the viewed perspective images of the target devices can be compared or using which the raw data can be processed into an alignment result.

In one embodiment, the display 106 uses an imaging technology other than a cathode ray rube (CRT). Examples of suitable technologies for the display 106 include a plasma display panel (PDP), a thin film transistor (TFT) device, a digital light processing (DLP) device, a liquid crystal on silicon (LCOS) device, a light emitting diode (LED) device, and an organic light emitting diode (OLED) device.

The display 106 may have a viewable area that measures greater than 19 inches diagonally. As one skilled in the art will appreciate, 19 inch CRT display devices can have considerable weight. The use of another display technology, such as TFTs can provide a larger viewing area with considerably less weight and power consumption.

The display 106 interfaces with the computing device 105 using a suitable interface technology. Examples of suitable interfaces include a component video interface, a broadband component interface, a high definition multimedia interface, a digital video interface, a red, green, blue (RGB) interface, and a video graphics array (VGA) interface. Further, a wireless interface may be used, such as the ROOMLINK system (which is commercially available from Sony Corp. of America of New York, N.Y.).

Having described embodiments of Display For Vehicle Diagnostic System (which are intended to be illustrative and not limiting), it is noted that modifications and variations can be made by persons skilled in the art in light of the above teachings. It is therefore to be understood that changes may be made in the particular embodiments disclosed that are within the scope and spirit of the present disclosure.

1. A vehicle diagnostic system comprising:
a computing device configured to perform a diagnostic function and to generate a result for the diagnostic function; and
a display coupled to the computing device configured to display the result, wherein the display implements non-cathode ray tube (CRT) technology.

2. The system of claim 1, wherein the display includes a viewable area measuring greater than 19 inches diagonally.

3. The system of claim 1, wherein the display comprises a plasma display panel (PDP).

4. The system of claim 1, wherein the display comprises a thin film transistor (TFT) device.

5. The system of claim 1, wherein the display comprises a digital light processing (DLP) device.

6. The system of claim 1, wherein the display comprises a liquid crystal on silicon (LCOS) device.

7. The system of claim 1, wherein the display comprises a light emitting diode (LED) device

8. The system of claim 1, wherein the display comprises an organic light emitting diode (OLED) device.

9. The system of claim 1, wherein the display interfaces with the computing devices using a component video interface.

10. The system of claim 1, wherein the display interfaces with the comprising devices using a broadband component interface.

11. The system of claim 1, wherein the display interfaces with the comprising device using a high definition multimedia interface.

12. The system of claim 1, wherein the display interfaces with the computing device using a digital video interface.

13. The system of claim 1, wherein the display interfaces with the computing devices using an RGB interface.

14. The system of claim 1, wherein the display interfaces with the computing devices using a VGA interface.

15. The system of claim 1, wherein, the display interfaces with the computing device using a wireless interface.
